(19) United States
(12) Patent Application Publication
(10) Pub. No.: US 2014/0158918 A1
(43) Pub. Date: Jun. 12, 2014

(54) IONIZING RADIATION BARRIERS AND METHODS OF MAKING SAME

(71) Applicant: DURACOTE CORPORATION, Ravenna, OH (US)

(72) Inventor: John A. Petroski, Ravenna, OH (US)

(73) Assignee: DURACOTE CORPORATION, Ravenna, OH (US)

(21) Appl. No.: 13/709,122

(22) Filed: Dec. 10, 2012

(51) Int. Cl. G21F 1/10

(52) U.S. Cl. CPC G21F 1/103; G21F 1/106
USPC 250/515.1; 252/478

(57) ABSTRACT

An ionizing radiation barrier includes a binder selected from thermoplastics, silicone elastomers, plastisols and organisols; and high density particles dispersed throughout said binder. The particles are preferably homogeneously dispersed and the radiation barrier is preferably devoid of air bubble and pin holes. The high density particles are radio-opaque so as to provide for radiation attenuation. A method of protecting a body from ionizing radiation includes positioning such an ionizing radiation barrier between an ionizing radiation source and a body to be protected. A method for producing an ionizing radiation barrier includes the steps of: homogeneously dispersing high density particles in a binder to create a loaded binder; deaerating the loaded binder to remove air bubbles; forming a desired structure from the loaded binder; and setting the loaded binder.

### FIELD OF THE INVENTION

The present invention generally relates to barriers for ionizing radiation and methods of making the same. The barriers are comprised of binders loaded with high density particles. In other embodiments, the loaded binders are part of protective garments for protection from ionizing radiation. In yet other embodiments, the present invention provides methods to protect a structure or body from ionizing radiation.

### BACKGROUND OF THE INVENTION

Ionizing radiation is generally harmful to living beings and thus steps are taken to reduce exposure to ionizing radiation even in those instances in which some exposure is required. For example, protective garments are worn by patients as well as medical staff when performing certain medical procedures involving ionizing radiation.

Unfortunately, the protective garments now employed are quite bulky, heavy and uncomfortable for both patients and medical staff. For example, the lead vests worn by patients obtaining x-ray images are extremely heavy and do not cover or drape over the patient in even a moderately comfortable manner. Similar garments are worn by medical staff, such as lead aprons and gloves and glandular wraps (e.g., thyroid shields) and skull caps. The art would benefit from new materials suitable for employment in garments protecting the wearer from ionizing radiation.

High density, radio-opaque materials such as lead, barium, tungsten, bismuth and lanthanum and the salts thereof, such as barium sulfate and bismuth oxide, have demonstrated the ability to attenuate ionizing radiation. However, while these raw materials may possess the potential to attenuate ionizing radiation, they have little if any commercial benefit in their powdered form. They must be worked into a useful medium that can be formed into useful constructs to deliver benefit to an end user. There is a need for articles capable of attenuating ionizing radiation which could be further converted into items used in the medical industry such as protective caps, collars, vests, gowns and skirts worn by medical professionals involved in fluoroscopic procedures and for surgical drapes for patients.

### SUMMARY OF THE INVENTION

In a first embodiment, this invention provides a ionizing radiation barrier comprising: a binder selected from thermoplastics, silicone elastomers, plastisols and organisols; and high density particles dispersed throughout said binder.

In a second embodiment, this invention provides an ionizing radiation barrier as in the first embodiment, wherein the high density particles are homogeneously dispersed throughout said binder.

In a third embodiment, this invention provides an ionizing radiation barrier as in either the first or second embodiment, wherein the ionizing radiation barrier is substantially devoid of pinholes and air bubbles.

In a fourth embodiment, this invention provides an ionizing radiation barrier as in any of the first through third embodiments, comprising greater than 2% by weight binder and greater than 25% by weight high density particles.

In a fifth embodiment, this invention provides an ionizing radiation barrier as in any of the first through fourth embodiments, comprising from 20% or less to 2% or more binder, and from 80% or more to 98% or less high density particles.

In a sixth embodiment, this invention provides an ionizing radiation barrier as in any of the first through fifth embodiments, wherein said high density particles are selected from lead, iron, calcium carbonate, bismuth, bismuth oxide, barium, barium sulfate, tungsten and lanthanum.

In a seventh embodiment, this invention provides an ionizing radiation barrier as in any of the first through sixth embodiments, wherein said binder is a thermoplastic selected from polyolefins, polyvinyl acetate, ethylene vinyl acetate, thermoplastic polyurethane, styrene-polyisoprene-styrene, and styrene-butadiene.

In a eighth embodiment, this invention provides an ionizing radiation barrier as in any of the first through seventh embodiments, further comprising an antioxidant.

In a ninth embodiment, this invention provides an ionizing radiation barrier as in any of the first through eighth embodiments, wherein said binder is formed of a two-part silicone elastomer system.

In a tenth embodiment, this invention provides an ionizing radiation barrier as in any of the first through ninth embodiments, wherein said binder is a plastisol.

In a eleventh embodiment, this invention provides an ionizing radiation barrier as in any of the first through tenth embodiments, wherein the plastisol includes from 25 to 45 weight percent (wt %) PVC homopolymer, from 40 to 70 wt % plasticizer, less than 15 wt % dispersant, from 0.2 to 1.0 wt % stabilizer and from 0.5 to 2 wt % air release agent.

In a twelfth embodiment, this invention provides an ionizing radiation barrier as in any of the first through eleventh embodiments, wherein the radiation barrier includes from 5 to 10 weight percent (wt %) PVC homopolymer; from 5 to 10 wt % dinonyl phthalate plasticizer; from 0.05 to 2 wt % barium-zinc stabilizer; from 0 to 2 wt % dispersant; from 0.1 to 0.5 wt % polyoxyalkylene compound; from 0.1 to 0.3 wt % moisture scavenger; and from 75 to 95 wt % high density particles.

In a thirteenth embodiment, this invention provides a method for producing an ionizing radiation barrier comprising the steps of: homogeneously dispersing high density particles in a binder to create a loaded binder; deaerating the loaded binder to remove air bubbles; forming a desired structure from the loaded binder; and setting the loaded binder.

In a fourteenth embodiment, this invention provides a method as in the thirteenth embodiment, wherein the loaded binder includes greater than 2% by weight binder and greater than 25% by weight high density particles.

In a fifteenth embodiment, this invention provides a method as in either the thirteenth or fourteenth embodiments, wherein the loaded binder includes from 20% or less to 2% or more binder, and from 80% or more to 98% or less high density particles.

In a sixteenth embodiment, this invention provides a method as in any of the thirteenth through fifteenth embodiments, wherein said high density particles are selected from lead, iron, calcium carbonate, bismuth, bismuth oxide, barium, barium sulfate, tungsten and lanthanum.

In a seventeenth embodiment, this invention provides a method as in any of the thirteenth through sixteenth embodiments, wherein in said step of setting, the high density particles remain homogeneously dispersed, and the radiation barrier remains free of air bubble and pin holes.

In an eighteenth embodiment, this invention provides a method as in any of the thirteenth through seventeenth embodiments, wherein said binder is a thermoplastic, and said step of setting the loaded binder includes cooling the thermoplastic.

In a nineteenth embodiment, this invention provides a method as in any of the thirteenth through eighteenth embodiments, wherein the thermoplastic is selected from polyolefins, polyvinyl acetate, ethylene vinyl acetate, thermoplastic polyurethane, styrene-polyisoprene-styrene, and styrene-butadiene

In a twentieth embodiment, this invention provides a method as in any of the thirteenth through nineteenth embodiments, wherein said binder is a two-part silicone elastomer having an A-part and B-part, and said step of homogeneously dispersing includes homogeneously dispersing high density particles first into the A-part and B-part separately.

In a twenty-first embodiment, this invention provides a method as in any of the thirteenth through twentieth embodiments, wherein said step of setting includes combining the A-part and B-part and allowing the silicone elastomer to cure.

In a twenty-second embodiment, this invention provides a method as in any of the thirteenth through twenty-first embodiments, wherein said step of deaerating is carried out by subjecting the loaded binder to a vacuum.

In a twenty-third embodiment, this invention provides a method as in any of the thirteenth through twenty-second embodiments, wherein the binder is a plastisol.

In a twenty-fourth embodiment, this invention provides a method as in any of the thirteenth through twenty-third embodiments, wherein the plastisol includes from 25 to 45 weight percent (wt %) PVC homopolymer, from 40 to 70 wt % plasticizer, less than 15 wt % dispersant, from 0.2 to 1.0 wt % stabilizer and from 0.5 to 2 wt % air release agent.

In a twenty-fifth embodiment, this invention provides a method as in any of the thirteenth through twenty-fourth embodiments, wherein the radiation barrier includes from 5 to 10 weight percent (wt %) PVC homopolymer; from 5 to 10 wt % dinonyl phthalate plasticizer; from 0.05 to 2 wt % barium-zinc stabilizer; from 0 to 2 wt % dispersant; from 0.1 to 0.5 wt % polyoxyalkylene compound; from 0.1 to 0.3 wt % moisture scavenger; and from 75 to 95 wt % high density particles

In a twenty-sixth embodiment, this invention provides a method of protecting a body from ionizing radiation comprising: positioning an ionizing radiation barrier between an ionizing radiation source and a body to be protected, the ionizing radiation barrier comprising: a binder selected from thermoplastics, silicone elastomers, plastisols and organisols; and high density particles dispersed throughout said binder.

In a twenty-seventh embodiment, this invention provides a method as in the twenty-sixth embodiment, wherein the high density particles are homogeneously dispersed throughout said binder.

In a twenty-eighth embodiment, this invention provides a method as in the either the twenty-sixth embodiment or the twenty-seventh embodiment, wherein the ionizing radiation barrier is substantially devoid of pinholes and air bubbles.

In a twenty-ninth embodiment, this invention provides a method as in the any of the twenty-sixth through twenty-eighth embodiments, comprising greater than 2% by weight binder and greater than 25% by weight high density particles.

In a thirtieth embodiment, this invention provides a method as in the any of the twenty-sixth through twenty-ninth embodiments, comprising from 20% or less to 2% or more binder, and from 80% or more to 98% or less high density particles.

In a thirty-first embodiment, this invention provides a method as in the any of the twenty-sixth through thirtieth embodiments, wherein said high density particles are selected from lead, iron, calcium carbonate, bismuth, bismuth oxide, barium, barium sulfate, tungsten and lanthanum.

In a thirty-second embodiment, this invention provides a method as in the any of the twenty-sixth through thirty-first embodiments, wherein said binder is a thermoplastic selected from polyolefins, polyvinyl acetate, ethylene vinyl acetate, thermoplastic polyurethane, styrene-polyisoprene-styrene, and styrene-butadiene.

In a thirty-third embodiment, this invention provides a method as in the any of the twenty-sixth through thirty-second embodiments, further comprising an antioxidant.

In a thirty-fourth embodiment, this invention provides a method as in the any of the twenty-sixth through thirty-fifth embodiments, wherein said binder is formed of a two-part silicone elastomer system.

In a thirty-fifth embodiment, this invention provides a method as in the any of the twenty-sixth through thirty-fourth embodiments, wherein said binder is a plastisol.

In a thirty-sixth embodiment, this invention provides a method as in the any of the twenty-sixth through thirty-fifth embodiments, wherein the plastisol includes from 25 to 45 weight percent (wt %) PVC homopolymer, from 40 to 70 wt % plasticizer, less than 15 wt % dispersant, from 0.2 to 1.0 wt % stabilizer and from 0.5 to 2 wt % air release agent.

### BRIEF DESCRIPTION OF THE DRAWINGS

FIG. 1 is a general schematic representation of a radiation barrier of this invention having a laminate structure of a loaded binder secured to a reinforcement layer.

### DETAILED DESCRIPTION OF ILLUSTRATIVE EMBODIMENTS

This invention is directed to barriers for ionizing radiation, herein broadly referred to as radiation barriers. The radiation barriers are comprised of high density particles suspended in a binder matrix. These radiation barriers may find application in a number of environments, and a particular focus of this invention is to provide radiation barriers suitable for use in medical garments for protection from ionizing radiation.

Particular embodiments are distinguished by the type of binder, which herein may include thermoplastics, silicone rubbers, plastisols and organisols. In each of these embodiments, various high density particles may be employed, including, but not limited to lead, iron, calcium carbonate, bismuth, bismuth oxide, barium, barium sulfate, tungsten and lanthanum. Specific embodiments are directed to particular binders loaded with particular particles.

The high density particles are chosen in order to impart protection from ionizing radiation, and thus are chosen to be radiopaque or relatively impenetrable to x-rays or other forms of radiation. In some embodiments, the high density particles may be selected from lead, iron, calcium carbonate, bismuth, bismuth oxide, barium, barium sulfate, tungsten and lanthanum. Of this group lead, bismuth, bismuth oxide, barium sulfate and tungsten are particularly useful in radiation barriers serving to attenuate ionizing radiation. Because of toxicity concerns, bismuth oxide, barium sulfate and tungsten are particularly useful.

The particles are preferably in the micron dimension range, generally understood as a powder form, in order to mix and disperse well in the binder system. In some embodiments, the high density particles have a particle size of from 0.15 micron to 30 microns.

Thermoplastic binders may be selected from polyolefins, polyvinyl acetate, ethylene vinyl acetate, thermoplastic polyurethane, styrene-polyisoprene-styrene, and styrene-butadiene. Suitable polyolefins include, but are not limited to, polyethylene, polypropylene, polymethylpentene (PMP), polybutylene, polyisobutylene (PIB), ethylene propylene rubber (EPR) and ethylene propylene diene monomer (EPDM). In particular embodiments, the polyethylene is linear low density polyethylene (LDPE), while, in others, it is high density polyethylene (HDPE).

In some embodiment, blends of the forgoing thermoplastics are employed. For example, polymers with higher molecular weights or glass transition temperatures may be blended with polymers of lower molecular weights or glass transition temperatures to optimize characteristics such as molten viscosities, elongation and flexibility. In a particular embodiment, polyvinyl acetate (PVAc) or ethylene vinyl acetate (EVA) is mixed with a higher melting point polyolefin to improve flexibility and elongation. These polymers can be blended at 10 to 50% of the total polymer weight.

When thermoplastic polymers are employed, antioxidants may be added to improve the thermal stability of the resin during processing to prevent thermal degradation. In particular embodiments, antioxidants may be selected from tetra-bis-methylene-3-(3,5-di-tert-butyl-4-hydroxyphenyl)propionate methane (Irganox 1010, Ciba Specialty Chemicals), 1,3,5-trimethyl-2,4,6-tris(3,5-di-tert-butyl-4-hydroxybenzl)benzene (Irganox 1330, Ciba Specialty Chemicals), and 2,2-methylene-bis(4-ethyl-6-tert-butyl phenol) (Cyanox 425, American Cyanamid Company). If employed, in some embodiments, the antioxidant may be present at from 0.5% or more to 10% or less by weight. In other embodiments, the antioxidant may be present at from 0.5% or more to 7% or less by weight, and in yet other embodiments, at from 0.5% or more to 5% or less by weight of the binder.

In another embodiment of this invention, the binder is chosen from liquid silicone polymers. One-part or two-part liquid silicone polymers can be employed. In particular embodiments, 2 part liquid silicones are employed, wherein addition cure is initiated when the part A and part B are mixed.

In some embodiments, this invention was intended for but not limited to production methods involving continuous web fed operation. Employing low viscosity liquid silicones allows the material to be coated using knife, roll or slot die coating heads. The activated system may be coated onto a carrier such as polytetrafluoroethylene (PTFE) coated fabric which may be removed to provide a cured, free standing barrier. This compound may also be coated directly on a substrate such as a nonwoven or woven textile to provide a reinforced laminated barrier.

Although liquid silicone-based radiation barriers can be produced using moisture cure or condensation cure, the most preferred cure mechanism for a roll fed production environment involves addition cure. Addition cure provides acceptable work-life yet is capable of accelerated cure by means of secondary heat and can be used in thick cross section materials.

In another embodiment of this invention, the binder is chosen from a plastisol or organisol. Herein, a plastisol is to be understood as a suspension of particles of polyvinyl chloride (PVC) homopolymer or copolymer blends in a plasticizer. The plastisol may also include other components known to those of ordinary skill in the art, such as processing stabilizers, dispersants and air release agents. The processing stabilizer generally provides heat stability so that the processing of the binder does not compromise it. The dispersant helps to maintain the suspension of PVC particles. The air release agent serves to serves to allow air entrained during the mixing process to escape during the coating process. This is critical in preventing pin holes or perforations which would allow radiation transmission.

As mentioned, the plastisol includes suspended particles of PVC homopolymer or copolymer blends in a plasticizer. In copolymer blends, the vinyl chloride monomer is polymerized along with a comonomer, such as ethylene vinyl, and the copolymer is suspended in a plasticizer. In particular embodiments, the copolymer blend includes at least 93% vinyl chloride monomer, in other embodiments, 95% vinyl chloride monomer, in other embodiments, 93% vinyl chloride monomer.

Suitable plasticizers include but are not limited to phthalates, non-orthophthales, citric acid esters, benzoates and adipates. Suitable phthalates include dinonyl phthalates, diisononyl phthalates (e.g., Hexamoll Dinch, BASF), diisoheptyl phthalates, diisodecyl phthalates, diisooctyl phthalates, and di-2-ethylhexl phthalates. Suitable non-orthophthalates include bis(2-ethylhexyl)terephthalate (Eastman 168™, Eastman, Tenn., USA). Suitable citric acid esters include acetyl tri-n-butyl citrate, acetyl tri-n-hexyl citrate and n-butyryl tri-n-hexyl citrate. Suitable benzoates include propylene glycol dibenzoate. Suitable adipates include diisononyl adipate and diisooctyl adipate.

As is generally known, plastisols may be processed at temperatures that can degrade the PVC homopolymer or copolymer. Thus, stabilizers are commonly employed, and, in this invention, any suitable stabilizer may be used. By way of non-limiting example, suitable stabilizers include but are not limited to mixed metals such as barium-zinc (Ba/Zn; e.g., Ferro Therm-Chek 1159-SF), calcium-zinc (Ca/Zn; e.g., Akrostab CAZ, Akcros Chemicals) and calcium, aluminum and magnesium-zinc (Ca/Al/Mg/Zn).

A dispersant is employed because a homogeneous distribution of particles has been found to be important to achieve uniform radiation attenuation. The dispersant will serve to suspend and disperse the high density particles during mixing, and further helps to prevent their settling and separation from the plastisol. Suitable dispersants are generally known. Suitable dispersants include but are not limited to BYK Disperplast-1148 (acidic ester with petroleum distillates, BYK-Chemie GmbH) and Pergosperse MO 400 (polyethylene glycol monooleate, Lonza Group Ltd).

An air release agent is preferably employed because it is important to avoid entrapping air in the plastisol, which can lead to air bubbles and or pin holes or other inconsistencies in the uniformity of the loaded binder. Pin holes or air pockets in a finished radiation barrier provide poor radiation attenuation and thus are to be avoided. Thus, the air release agent is employed to allow the escape of entrained air from the plastisol binder. Suitable air release agents are generally known, and in some embodiments, suitable air release agents include but are not limited to BYK-3155 (polyoxyalkylene, BYK-Chemie GmbH) and BYK-3105 (methylalkyl polysiloxane, BYK-Chemie GmbH.

Sometimes moisture in the mix, whatever source it comes from, can negatively effect the resultant radiation barrier, particularly by creating pin holes or air bubbles by evaporation during processing. To avoid the negative consequences of the presence of moisture, a moisture scavenger may be employed. Thus, in some embodiments the plastisol binder includes a moisture scavenger, for example, calcium oxide.

An organisol is a plastisol, as above, that further includes a small amount of solvent to reduce viscosity, the solvent being later driven off (flashed off). The creation of an organisol may be found desirable to provide a binder of reduced viscosity in order to improve its ability to coat a desired substrate or release layer. Suitable solvents include but are not limited to toluene, methyl ethyl ketone, methyl isobutyl ketone, cyclohexanone, and isobutyl acetate.

In some embodiments, the loaded binder may be comprised of from 2% or more to 75% or less by weight of the binder. In yet other embodiments, the loaded binder may include from 5% or more to 75% or less binder, in yet other embodiments, from 5% or more to 40% or less binder, and in yet other embodiments, from 5% or more to 20% or less binder. In some embodiments, the amount of binder is equal to or greater than 2% by weight, in other embodiments, 5%, in other embodiments, 7%, in other embodiments, 10%, and, in other embodiments, 15% by weight. In other embodiments, the amount of binder is equal to or less than 75%, in other embodiments, 50%, in other embodiments 30%, in other embodiments, 25%, in other embodiments 20%, in other embodiments 15% and in other embodiments 10% by weight.

In some embodiments, the loaded binder comprises from 98% or less to 25% or more high density particles by weight. In yet other embodiments, the loaded binder may include from 95% or less to 25% or more high density particles by weight, in other embodiments, from 95% or less to 60% or more high density particles and, in yet other embodiments, from 95% or less to 80% or more high density particles. In some embodiments, the amount of high density particles is equal to or less than 98% by weight, in other embodiments, 95% by weight, in other embodiments, 93% by weight, in other embodiments, 90% by weight, and in other embodiments, 85% by weight. In other embodiments, the amount of binder is equal to or greater than 25% by weight, in other embodiments, 50% by weight, in other embodiments 70% by weight, in other embodiments, 75%, in other embodiments 80%, in other embodiments 85% and in other embodiments 90%.

The amount of particle loading will affect the viscosity of the loaded binder. In some embodiments, the loaded binder has a viscosity of from 1500 or more to 20,000 or less centipoise (cPs). In other embodiment, the loaded binder has a viscosity of from 4,500 cPs or more to 12,500 cPs or less. This range makes the loaded binder suitable for knife, slot die or reverse roll coating.

In some thermoplastic-based binder embodiments, the thermoplastic binder includes from 0.05% or more to 10% or less by weight antioxidant. In yet other embodiments, the thermoplastic binder may include from 0.05% or more to 7% or less antioxidant, and in yet other embodiments, from 0.05% or more to 5% or less antioxidant.

In some thermoplastic-based binder embodiments, the thermoplastic binder is comprised of 0.05% or greater antioxidant by weight, in yet other embodiments, 0.75% or greater, in other embodiments, 1.25% or greater, in other embodiments, 2% or greater, and in yet other embodiments, 3.0% or greater. In some embodiments, the thermoplastic binder is comprised of 10% or less antioxidant by weight. In other embodiments, the thermoplastic binder is comprised of 7.5% or less antioxidant, in other embodiments, 5% or less, in other embodiments, 4% or less, in other embodiments, 3.0% or less, and in other embodiments, 2% or less.

In some plastisol-based binder embodiments, the plastisol binder includes from 25 wt % or more to 45 wt % or less PVC homopolymer or copolymer blend, as described above. In other embodiments, the plastisol binder includes from 30 wt % or more to 40 wt % or less, in other embodiments, from 32 wt % or more to 40 wt % or less, and in other embodiments, from 32% or more to 38% or less PVC homopolymer or copolymer blend.

In some plastisol-based binder embodiments, the plastisol binder includes from 40 wt % or more to 70 wt % or less plasticizer. In other embodiments the plastisol binder includes from 45 wt % or more to 65 wt % or less plasticizer, in other embodiments, from 47% or more to 62% or less, and, in other embodiments, from 50 wt % or more to 60 wt % or less plasticizer.

In some embodiments, the plastisol binder includes from 0.2 wt % or more to 1 wt % or less stabilizer. In other embodiments the plastisol binder includes from 0.4 wt % or more to 0.6 wt % or less stabilizer.

In some embodiments, the plastisol binder includes from 0 wt % or more to 15 wt % or less dispersant. In other embodiments, the plastisol binder includes from 2 wt % or more to 15 wt % or less dispersant, in other embodiments, from 5 wt % or more to 12 wt % or less, and, in other embodiments, from 8 wt % or more to 12 wt % or less.

In some embodiments, the plastisol binder includes from 0.5 wt % or more to 2 wt % or less air release agent. In other embodiments the plastisol binder includes from 0.5 wt % or more to 1.5 wt % or less air release agent, and in other embodiments, from 0.5 wt % or more to 1.0 wt % or less air release agent.

In some embodiments, the plastisol binder includes from 0 wt % or more to 2 wt % or less moisture scavenger. In other embodiments the plastisol binder includes from 0.5 wt % or more to 1.5 wt % or less moisture scavenger, and in other embodiments, from 0.5 wt % or more to 1.0 wt % or less moisture scavenger.

In some organisol-based binder embodiments, the organisol binder includes a solvent to further reduce viscosity to the desired range. In some embodiments, the organisol includes from 0.5% to 10% by weight solvent.

The thermoplastic binder embodiments can be mixed in any suitable heated mixer, such as multi-shaft mixer dispersers, sigma mixers, roll mills or twin screw extruders. The thermoplastic resin and any antioxidants/stabilizers are first added, and mixed and heated as necessary to soften the thermoplastic binder for receipt of the high density particles. After the thermoplastic resin is softened, the high density particles are introduced and further mixing disperses the particles. In particular embodiments, the resin and particles are mixed in high shear conditions to ensure a homogeneous dispersion of the high density particles. The mixture is also deaerated, which will be described more fully below.

Once the high density particles are homogeneously dispersed and the mixture deaerated, the molten loaded thermoplastic binder can be sprayed, extruded or coated onto a substrate. Upon cooling, the thermoplastic will set and solidify to provide the end product barrier. If the substrate bears a release coating (e.g., silicone), the barrier can be removed in an unsupported form. Laminate forms could also be created, as disclosed more fully below. For example the molten compound may be extruded through a slot die onto a release-coated carrier in a roll fed arrangement, cooled and removed from the release-coated carrier.

Thermoplastic compounds are unique in that they may be recycled/reclaimed. For instance if a film of loaded binder is die cut to some useful shape, trim and waste may be remelted and cast into useful products.

The silicone binder embodiments may be based on one-part or two-part cure systems. The one-part systems cure by condensation cure or moisture cure, while, in the two-part systems, cure is initiated when a part A and part B are mixed (addition cure). Addition cure provides acceptable work-life yet is capable of accelerated cure by means of secondary heat.

In one-part silicone cure systems, the silicone elastomer is mixed with the metal particles under vacuum to avoid moisture that would prematurely initiate curing. Temperature controls may also be necessary to avoid heat curing. After dispersion of the high density particles, the one-part silicone elastomer is cast to the desired form and the loaded binder is exposed to air so that atmospheric moisture triggers curing.

In two-part silicone cure systems, curing is initiated when the part A and part B silicone elastomers are mixed. Therefore in particular embodiments, the high density particles are first dispersed in either the A-side or the B-side or both before bringing them together to begin curing. In embodiments with high loading of high density particles, it will be advantageous to mix a portion of the high density particles into the A-side and a portion into the B-side so that each part, the A-side and B-side, remains workable, without having too high of a particle loading, which could cause the mixture to be doughy, having too much particle filler and not enough binder. The A-side and B-side will be mixed per the suppliers suggested mix ratios. The mixture will be deaerated, as described more fully below.

Once the high density particles are homogeneously dispersed and the mixture deaerated, the loaded silicone elastomer binder can be sprayed, extruded or coated onto a substrate. Upon cooling, the silicone elastomer will cure and solidify to provide the end product barrier. The curing can be accelerated by the application of heat. If the substrate bears a release coating (e.g., silicone), the barrier can be removed in an unsupported form. Laminate forms could also be created, as disclosed more fully below.

In plastisol embodiments, the PVC and comonomer, if any, are added to a mixing vessel along with the plasticizer, and both are mixed under moderate speed. In the case of an organisol, the solvent would also be added and mixed. Thereafter, the stabilizer(s), air release agent(s) and dispersant(s) are added and mixed until homogeneous. The high density particles and resin are last added under higher mixing speed/shear, and everything is mixed until homogeneous. The mixture will be deaerated, as described more fully below.

Once the high density particles are homogeneously dispersed and the mixture deaerated, the plastisol loaded binder can be sprayed, extruded or coated onto a substrate. Upon cooling, the plastisol will fuse and solidify to provide the end product barrier. If the substrate bears a release coating (e.g., silicone), the barrier can be removed in an unsupported form. Laminate forms could also be created, as disclosed more fully below.

To optimize ionizing radiation attenuating performance in all of these binder systems, the high density particles should be homogeneously suspended, should be of substantially uniform thickness/weight and should contain no pin holes or air bubbles, which would negatively serve as points for radiation penetration. If any of these characteristics is not met, radiation attenuation may be compromised and the end product might be unsuitable due to potential radiation exposure.

Homogeneity is achieved by using high shear or high dispersing energy mixing and allowing adequate mixing time, usually at least 15 minutes, under shear, to disperse the high density particles. Care must be exercised with viscous compounds which may overheat due to friction. In some embodiments, the high density particles are uniformly dispersed throughout the radiation barrier.

The presence of pinholes and air bubbles can be particularly troublesome because the serve as points for radiation penetration. Therefore, in particular embodiments, vacuum de-aeration is performed, either during the mixing step or immediately afterward, to de-aerate the binder. Any entrained air will result in penetration points, which allow radiation penetration, and cannot be tolerated. Thus, in particular embodiments, the radiation barrier is substantially devoid of pin holes and air bubbles, wherein it is to be understood that by “substantially devoid” it is meant that the barrier lacks pin holes and air bubbles to a sufficient extent to be suitable for use in blocking ionizing radiation. In other embodiments, the radiation barrier is devoid of pin holes and air bubbles.

Attenuating performance is also greatly affected by thickness and coating weight. For a compound with a homogeneous dispersion of particles, any areas below the targeted thickness/coat weight will not attenuate as expected. The most preferred coating techniques regardless of the binder system would include slot die extrusion and precision knife or reverse roll coaters. In some embodiments, the radiation barriers of this invention are cast or coated to a thickness suitable for achieving a desired weight per area. In some embodiments, the radiation barrier is formed at thickness suitable for providing a radiation barrier of from 40 oz/square yard to 125 oz/square yard. In other embodiments, the radiation barrier has a weight of from 50 to 80 oz/square yard. In particular embodiments, the radiation barrier is of uniform thickness.

Radiation barriers in accordance with this invention may be formed from free-standing loaded binders as taught herein. The radiation barriers might also be formed as a laminate structure wherein the loaded binders of this invention are incorporated as one or more layers therein.

The free-standing radiation barrier would be created by coating or casting the loaded binder onto an appropriate release substrate such that, once the loaded binder is cured or otherwise set, the resulting barrier can be removed from the substrate for use. It can be used in its free-standing form or could be enveloped in fabric to provide a useful article such as a skull cap or thyroid collar for ionizing radiation protection.

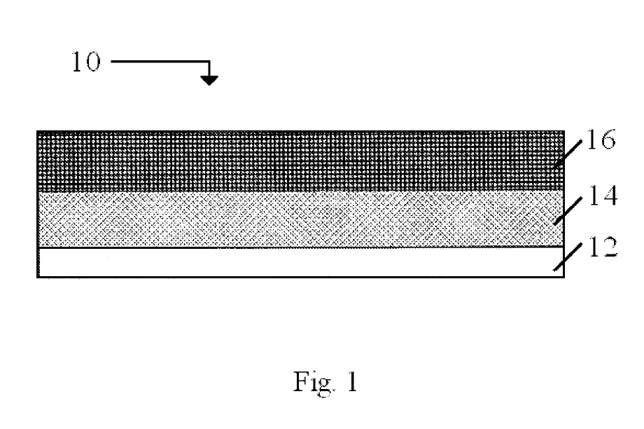

A laminate radiation barrier would include one or more reinforcement layers and one or more loaded binder layers. The most basic form would be a carrier substrate to which a loaded binder layer is adhered. Such a laminate is shown in FIG. 1 and designated by the numeral 10. The laminate 10 includes a release layer substrate 12, and a loaded binder 14 of this invention is cast or coated thereto. After the loaded binder has been compounded and metered onto the release layer substrate 12, but before fusing, curing, or cooling, a reinforcement layer 16 is inserted onto the open liquid surface. The loaded binder 14 will wet the surface of the reinforcement layer 16, and the loaded binder would then be fused, cured, or cooled to bind and/or entrap the reinforcement layer 16 at the interface between the loaded binder and reinforcement layer. The resulting composite will have a greater handling strength as compared to either the loaded binder 14 or reinforcement layer 16 alone. The loaded binder 14 would be cast directly onto the carrier substrate 12 and while still resinous and tacky, a reinforcement layer 16 would be placed in contact with the exposed surface thereof, and, when the loaded binder completely sets or cures, a completed laminate 10 is formed. This general concept could be employed to create laminates with multiple layers, and it will be appreciated that a release substrate need not be provided, i.e., the release substrate could be a reinforcement layer instead.

The reinforcement component may be chosen from a film or fabric. In some embodiments, the reinforcement component is a film selected from polyesters, polyurethanes, polyolefins, or vinyls. In particular embodiments, the film is chosen from polyester. In some embodiments, the reinforcement component is a fabric selected from plain weave fabrics, leno weave fabrics and non-woven fabrics. In a particular embodiment, the fabric is selected from plain weave polyester.

In particular embodiments, the binder is a thermoplastic resin selected from polyethylene and polypropylene, with antioxidant, and the high density particles are selected from barium sulfate or bismuth oxide. In such embodiments, the loaded binder includes from 5% to 20% by weight thermoplastic resin binder and from 95% to 80% by weight high density particles.

In particular embodiments, the binder is a two-part silicone elastomer from Dow Corning, namely 3-4237 dielectric firm gel part A and 3-4237 dielectric firm gel part B, and the high density particles are chosen as above. In other embodiments, the high density particles are barium sulfate or bismuth oxide. The loaded silicone binder includes from 3% to 25% by weight silicone elastomer and from 97% to 75% by weight high density particles.

In other particular embodiments, the binder is a two-part silicone elastomer from Momentive, namely LIM6040 part A and LIM6040 part B, and the high density particles are chosen as above. In other embodiments, the high density particles are barium sulfate or bismuth oxide. The loaded silicone binder includes from 10% to 25% by weight silicone elastomer and from 90% to 75% by weight high density particles.

In particular embodiments, the binder is a plastisol, and the radiation barrier includes from 5 to 10 weight percent PVC homopolymer; from 5 to 10 wt % dinonyl phthalate plasticizer; from 0.05 to 2 weight percent barium-zinc stabilizer; from 0 to 2 wt % dispersant (DISPERPLAST™ 1148, from Byk Additives and Instruments; polymeric wetting and dispersing agent of acidic ester and petroleum distallates); from 0.1 to 0.5 wt % polyoxyalkylene compound (air release); from 0.1 to 0.3 wt % moisture scavenger; and from 75 to 95 wt % high density particles and a viscosity of from 12,000 to 17,000 cPs. In some embodiments, the particles are barium sulfate. In other embodiments, the particles are bismuth oxide. The radiation barrier is cast to a weight of from 40 to 125 oz/square yard, preferably from about 50 to 80 oz/square yard.

In light of the foregoing, it should be appreciated that the present invention significantly advances the art by providing radiation barriers that are structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

### EXAMPLES

### Plastisol Embodiments

Particular embodiments of plastisol-based radiation barriers were formulated according to the following table, wherein, in one instance, the high density particles are barium sulfate particles with a particle size of from 15 to 20 microns, and, in another instance, are bismuth oxide particles with a particle size of 0.2 microns. The bismuth oxide embodiment was cast at different weights, namely, 81.0+/−1.5 oz/square yard and 61.5+/−1.5 oz/square yard.

| | Barium Sulfate1500 | Bismuth Oxide |
|---|---|---|
| Dinonyl Phthalate Plasticizer | 8.9% | 7.85% |
| Barium-Zinc Stabilizer | 0.1% | 0.05% |
| Polyoxyalkylene Compound | 0.2% | 0.1% |
| (air release) | | |
| PVC Dispersion | 6.6% | 4.5% |
| Homoploymer | | |
| Dispersplas 1148 (dispersant) | 2.0% | — |
| Calcium Oxide | 0.2% | 0.1% |
| Barium Sulfate | 82.0% | — |
| Bismuth III Oxide | — | 87.4% |
| Weight (oz./yd²) | 51.7 +/− 1.5 | 81.0 +/− 1.5 |
| | | 61.5 +/− 1.5 |
| Particle size | 15-20 μm | 0.2 μm |
| Viscosity range (cps.) | 12,000-17,000 | 4,500-8500 |

Each of these were cast onto a substrate with an appropriate release layer and after complete fusing of the formulations were removed from the substrate to provide a free standing radiation barrier. Each such barrier was found to adequately protect (i.e., block) against ionizing radiation.

### Laminate Embodiment

In order to demonstrate the usefulness of a laminated structure, the bismuth oxide embodiment at 61.5 oz/yd² from above was tested as to trap tear, cut strip, elongation and grab tensile, both as a stand alone barrier (Non-reinforced column) and as a laminate, wherein the loaded binder was secured to a 2 oz/yd² plain weave polyester fabric (Reinforced column) The tests were run in both the warp and fill directions, as seen in the table.

| | | Non- | |
|---|---|---|---|
| Test | Orientation | reinforced | Reinforced |
| Trap Tear | Warp | 0.77 | 8.1 |
| lbs. | Fill | 0.87 | 12.5 |
| ASTM D117 | | | |
| Cut Strip | Warp | 2.70 | 57.3 |
| lbs. | Fill | 2.77 | 56.5 |
| FSTM191.5102 | | | |
| Elongation | Warp | 169.1 | 14.0 |
| % | Fill | 244.7 | 25.1 |
| FSTM191.5102 | | | |
| Grab Tensile | Warp | 6.5 | 82.6 |
| lbs. | Fill | 6.6 | 93.1 |
| FSTM191.5100 | | | |

It will be readily appreciated that the laminate structure has significantly improved properties for use as a radiation barrier.

1. An ionizing radiation barrier comprising:
a binder selected from silicone elastomers, plastisols and organisols; and
high density particles dispersed throughout said binder.

2. The ionizing radiation barrier of claim 1, wherein the high density particles are homogeneously dispersed throughout said binder.

3. The ionizing radiation barrier of claim 1, wherein the ionizing radiation barrier is substantially devoid of pinholes and air bubbles.

4. The ionizing radiation barrier of claim 1, comprising greater than 2% by weight binder and greater than 25% by weight high density particles.

5. The ionizing radiation barrier of claim 1, comprising from 20% or less to 2% or more binder, and from 80% or more to 98% or less high density particles.

6. The ionizing radiation barrier of claim 1, wherein said high density particles are selected from lead, iron, calcium carbonate, bismuth, bismuth oxide, barium, barium sulfate, tungsten and lanthanum.

7. (canceled)

8. The ionizing radiation barrier of claim 7, further comprising an antioxidant.

9. The ionizing radiation barrier of claim 1, wherein said binder is formed of a two-part silicone elastomer system.

10. The ionizing radiation barrier of claim 1, wherein said binder is a plastisol.

11. The ionizing radiation barrier of claim 10, wherein the plastisol includes 25 to 45 weight percent (wt %) PVC homopolymer, from 40 to 70 wt % plasticizer, less than 15 wt % dispersant, from 0.2 to 1.0 wt % stabilizer and from 0.5 to 2 wt % air release agent.

12. The ionizing radiation barrier of claim 10, wherein the radiation barrier includes from 5 to 10 weight percent (wt %) PVC homopolymer; from 5 to 10 wt % dinonyl phthalate plasticizer; from 0.05 to 2 wt % barium-zinc stabilizer; from 0 to 2 wt % dispersant; from 0.1 to 0.5 wt % polyoxyalkylene compound; from 0.1 to 0.3 wt % moisture scavenger; and from 75 to 95 wt % high density particles.

13. A method for producing an ionizing radiation barrier comprising the steps of: homogeneously dispersing high density particles in a binder to create a loaded binder; deaerating the loaded binder to remove air bubbles; forming a desired structure from the loaded binder; and setting the loaded binder.

14. The method of claim 13, wherein the loaded binder includes greater than 2% by weight binder and greater than 25% by weight high density particles.

15. The method of claim 13, wherein the loaded binder includes from 20% or less to 2% or more binder, and from 80% or more to 98% or less high density particles.

16. The method of claim 13, wherein said high density particles are selected from lead, iron, calcium carbonate, bismuth, bismuth oxide, barium, barium sulfate, tungsten and lanthanum.

17. The method of claim 13, wherein in said step of setting, the high density particles remain homogeneously dispersed, and the radiation barrier remains free of air bubble and pin holes.

18. A method of protecting a body from ionizing radiation comprising:
positioning an ionizing radiation barrier between an ionizing radiation source and a body to be protected, the ionizing radiation barrier comprising:
a binder selected from silicone elastomers, plastisols and organisols; and
high density particles dispersed throughout said binder.

19. The method of claim 26, wherein the high density particles are homogeneously dispersed throughout said binder.

20. The method of claim 26, wherein the ionizing radiation barrier is substantially devoid of pinholes and air bubbles.
